(19) United States
(12) Patent Application Publication
(10) Pub. No.: US 2016/0279776 A1
(43) Pub. Date: Sep. 29, 2016

(54) Machine-Tool Device

(71) Applicant: ROBERT BOSCH GMBH, Stuttgart (DE)

(72) Inventors: Bernd Wirnitzer, Friolzheim (DE); Helge Sprenger, Stuttgart (DE); Hagen Philipp Keinath, Stuttgart (DE)

(21) Appl. No.: 15/036,281

(22) PCT Filed: Nov. 6, 2014
(86) PCT No.: PCT/EP2014/073924

§ 371 Date: May 12, 2016

(30) Foreign Application Priority Data
Dec. 3, 2013 (DE) 10 2013 224 759.1

(51) Int. Cl. B25D 11/00; B25F 5/00

(52) U.S. Cl. CPC B25D 11/005; B25F 5/00; B25D 2250/201; B25D 2250/221

(57) ABSTRACT

A machine-tool device includes at least one control and/or regulation unit. The at least one control and/or regulation unit is configured to (i) at least one of control and/or regulation of a drive unit and (ii) determine at least one actual rotational speed of the drive unit from a signal of at least one sensor element taking the form of an acceleration sensor. The machine-tool device further includes at least one sensor unit which includes the at least one sensor element taking the form of the acceleration sensor.

### STATE OF THE ART

Machine-tool devices, particularly manual machine-tool devices, are already known that exhibit a control and/or regulation unit, for control and/or regulation of a drive unit, and at least one sensor unit, said sensor unit including at least one sensor element taking the form of an acceleration sensor.

### DISCLOSURE OF THE INVENTION

The invention takes as its starting-point a machine-tool device, in particular a manual machine-tool device, with at least one control and/or regulation unit, for control and/or regulation of a drive unit, and with at least one sensor unit which includes at least one sensor element taking the form of an acceleration sensor.

It is proposed that the control and/or regulation unit is provided at least to determine at least one actual rotational speed of the drive unit from a signal of the sensor element taking the form of an acceleration sensor. The term “provided” is to be understood to mean, in particular, specially programmed, specially designed and/or specially equipped. A statement that an element and/or a unit is provided for a particular function is to be understood to mean, in particular, that the element and/or the unit fulfil(s) and/or perform(s) this particular function in at least one application condition and/or operating condition. The machine-tool device preferably takes the form of a manual-machine-tool regulation device which is provided for regulation of a set rotational speed of the drive unit. The drive unit preferably takes the form of an electric-motor unit. In this case, the drive unit may take the form of an a.c. electric-motor unit or a d.c. motor unit. The control and/or regulation unit is preferably provided to control and/or regulate a rotational speed of the drive unit. A “control and/or regulation unit” is to be understood to mean, in particular, a unit with at least one electronic control circuit. An “electronic control circuit” is to be understood to mean, in particular, a unit with a processor unit and with a memory unit and also with an operating program stored in the memory unit. The control and/or regulation unit preferentially receives electrical signals of the sensor unit, which are taken into account in the course of control and/or regulation of the drive unit. For this purpose, the control and/or regulation unit has preferentially been connected to the sensor unit at least electrically and/or for data processing. In this case the control and/or regulation unit may have been connected to the sensor unit in hard-wired or wireless manner. The control and/or regulation unit includes, in particular, an operating program and/or an operating function that exhibit(s) at least one algorithm for determination of an actual rotational speed of the drive unit from a signal of the sensor element taking the form of an acceleration sensor. The actual rotational speed of the drive unit can preferentially be determined by means of a Fourier analysis, by means of a phase-locked loop (PLL) and/or by means of a frequency comb (covariance) from a signal of the sensor element taking the form of an acceleration sensor. In addition, a determination of rotational speed by means of a method for determination of a cycle duration from a time signal is conceivable, in which a time between two signal peaks or two zero crossings of the acceleration signal is measurable and a frequency is ascertainable therefrom. Depending on a signal quality, in this case a preprocessing by means of a band-pass filter is appropriate. Alternatively, the time between several signal peaks or zero crossings is ascertainable, as a result of which the calculated frequency has been averaged over several periods.

The sensor element taking the form of an acceleration sensor is preferentially provided to record acceleration values that are oriented at least substantially parallel to a drive axis, in particular an axis of rotation, of the drive unit and/or that are oriented at least substantially parallel to an axis of rotation of a tool socket of the machine tool. However, it is also conceivable that the sensor element taking the form of an acceleration sensor is alternatively or additionally provided to record acceleration values that are oriented at least substantially perpendicular to a drive axis, in particular an axis of rotation, of the drive unit. The term “substantially parallel” here is to be understood to mean, in particular, an orientation of a direction relative to a reference direction, in particular in a plane, said direction exhibiting a deviation in relation to the reference direction of, in particular, less than 8°, advantageously less than 5°, and particularly advantageously less than 2°. The expression “substantially perpendicular” here is intended to define, in particular, an orientation of a direction relative to a reference direction, said direction and said reference direction including, in particular viewed in a plane, an angle of 90°, and said angle exhibiting a maximum deviation of, in particular, less than 8°, advantageously less than 5°, and particularly advantageously less than 2°. Particularly preferably, the sensor element taking the form of an acceleration sensor is provided to record acceleration values caused by a striking-mechanism unit. By means of the configuration, according to the invention, of the machine-tool device, an inexpensive device for determination of an actual rotational speed of the drive unit can be realized advantageously. Speed sensors that are already known and that have been arranged on a fan wheel, for example, can therefore be dispensed with advantageously. Consequently a saving can advantageously be made on production costs, assembly costs and assembly effort, since high manufacturing tolerances in the region of the fan wheel are possible as a consequence of elimination of a speed sensor arranged on the fan wheel.

The control and/or regulation unit is advantageously provided at least to adjust a rotational speed of the drive unit as a function of a signal of the sensor element taking the form of an acceleration sensor. By this means, an adjustment of a rotational speed of the drive unit can be obtained in structurally simple manner. In addition, costs for a device for adjustment of the rotational speed of the drive unit can consequently be kept down advantageously.

Moreover, it is proposed that the sensor unit exhibits at least one further sensor element taking the form of a current sensor. The further sensor element taking the form of a current sensor is preferably provided for measurement of a drive-unit current, in particular a current consumed by the drive unit. Consequently a further characteristic quantity of the drive unit can advantageously be registered which can be utilized for further processing by means of the control and/or regulation unit.

Furthermore, it is proposed that the control and/or regulation unit is provided at least to adjust a rotational speed of the drive unit as a function of a signal of the sensor element taking the form of an acceleration sensor and as a function of a signal of the further sensor element taking the form of a current sensor. A recognition of an operating condition, in particular a striking mode or an idling mode of a striking-mechanism unit, can advantageously be made possible. Consequently an advantageous adaptation of a rotational speed of the drive unit to an operating condition can be undertaken. In one configuration of a manual machine tool with a striking-mechanism device, including the machine-tool device, in addition a safe starting of the striking-mechanism device can be obtained advantageously, since the striking-mechanism device can be started up from a low initial striking-rate. Furthermore, as a consequence of an adaptation of a rotational speed of the drive unit to an operating condition, an increase in power of the striking-mechanism device can be obtained advantageously. In addition, a low-vibration behavior of the manual machine tool in idling mode can advantageously be made possible as a consequence of a low rotational speed.

In addition, it is proposed that the sensor unit exhibits at least one additional sensor element taking the form of a voltage sensor. The additional sensor element taking the form of a voltage sensor is preferably provided for measurement of a drive-unit voltage, in particular a voltage picked up by the drive unit. Consequently a further characteristic quantity of the drive unit can advantageously be registered which can be utilized for further processing by means of the control and/or regulation unit.

Moreover, it is proposed that the control and/or regulation unit is provided at least to adjust a rotational speed of the drive unit as a function of a signal of the sensor element taking the form of an acceleration sensor, as a function of a signal of the further sensor element taking the form of a current sensor, and as a function of a signal of the additional sensor element taking the form of a voltage sensor. By means of the configuration according to the invention, an actual rotational speed of the drive unit can advantageously be determined which can be utilized for exact adjustment of a set rotational speed of the drive unit. Consequently an exact adjustment of a set rotational speed of the drive unit can advantageously be undertaken in ongoing operation of the drive unit.

It is furthermore proposed that the control and/or regulation unit includes at least one voltage and/or current regulator for adjustment of the rotational speed of the drive unit, which is provided to take into account a characteristic quantity of the rotational speed that has been generated from a signal of the sensor element taking the form of an acceleration sensor. In addition, the voltage and/or current regulator for adjustment of the rotational speed preferentially additionally take(s) into account the signals of the further sensor element taking the form of a current sensor, and of the additional sensor element taking the form of a voltage sensor, for adjustment of the rotational speed. Advantageously, a deviation of a set rotational speed of the drive unit can advantageously be kept small, since an actual rotational speed of the drive unit is capable of being taken into account in the course of a regulation of a rotational speed by means of the voltage and/or current regulator.

In addition, a machine tool, in particular a manual machine tool, with at least one machine-tool device according to the invention is proposed. A “manual machine tool” here is to be understood to mean, in particular, a machine tool for machining of workpieces that is able to be transported by an operator without a transporting machine. The manual machine tool has, in particular, a mass that is less than 40 kg, preferably less than 10 kg, and particularly preferably less than 5 kg. Particularly preferably, the machine tool takes the form of a drilling hammer and/or chipping hammer. However, it is also conceivable that the machine tool exhibits a different configuration appearing appropriate to a person skilled in the art, such as, for example, a configuration as a drilling machine, as a cordless screwdriver, as an angle-grinder, as a jigsaw, as a sabre saw, as a gardening machine etc. The machine tool, in particular the manual machine tool, may in this connection take the form of a battery-operated or power-cable-operated machine tool. By means of the configuration according to the invention, a precise adjustment of a rotational speed of the drive unit of the machine tool can be realized advantageously. Consequently a specific rotational speed for a machining case can advantageously be adjusted exactly. This can advantageously lead to a precise result of working.

Moreover, a method is proposed for control and/or regulation of a rotational speed of a drive unit of a machine tool with at least one machine-tool device according to the invention. A precise regulation of the drive unit can be realized advantageously.

Furthermore, with regard to the method according to the invention it is proposed that the control and/or regulation unit determines at least one frequency of a periodic acceleration, by means of which an actual rotational speed of the drive unit can be determined. Consequently an inexpensive registration of an actual rotational speed of the drive unit can be realized which can be utilized particularly advantageously for adjustment of a set rotational speed of the drive unit.

In addition, with regard to the method according to the invention it is proposed that the control and/or regulation unit carries out at least one adaptation of a parameter characteristic of the drive unit which has been saved in a memory unit of the control and/or regulation unit for adjustment of a set rotational speed of the drive unit. In ongoing operation an application-specific adjustment of a parameter characteristic can advantageously be made possible which enables a precise adjustment of a set rotational speed.

The machine-tool device according to the invention, the machine tool according to the invention and/or the method according to the invention is/are not intended to be restricted to the application and practical form described above. In particular, the machine-tool device according to the invention, the machine tool according to the invention and/or the method according to the invention may, for fulfilment of a mode of operation described herein, exhibit a number of individual elements, components and units differing from a number stated herein.

### DRAWING

Further advantages arise out of the following description of the drawing. Embodiments of the invention are represented in the drawing. The drawing, the description and the claims contain numerous features in combination. A person skilled in the art will expediently also consider the features individually and will combine them to form meaningful further combinations.

Shown are:

FIG. 1 a machine tool according to the invention with at least one machine-tool device according to the invention in a schematic representation,

FIG. 2 a detailed view of the machine-tool device according to the invention in a schematic representation,

FIG. 3 a detailed view of an alternative machine-tool device according to the invention in a schematic representation,

FIG. 4 a detailed view of another alternative machine-tool device according to the invention in a schematic representation, and

FIG. 5 a detailed view of another alternative machine-tool device according to the invention in a schematic representation.

### DESCRIPTION OF THE EMBODIMENTS

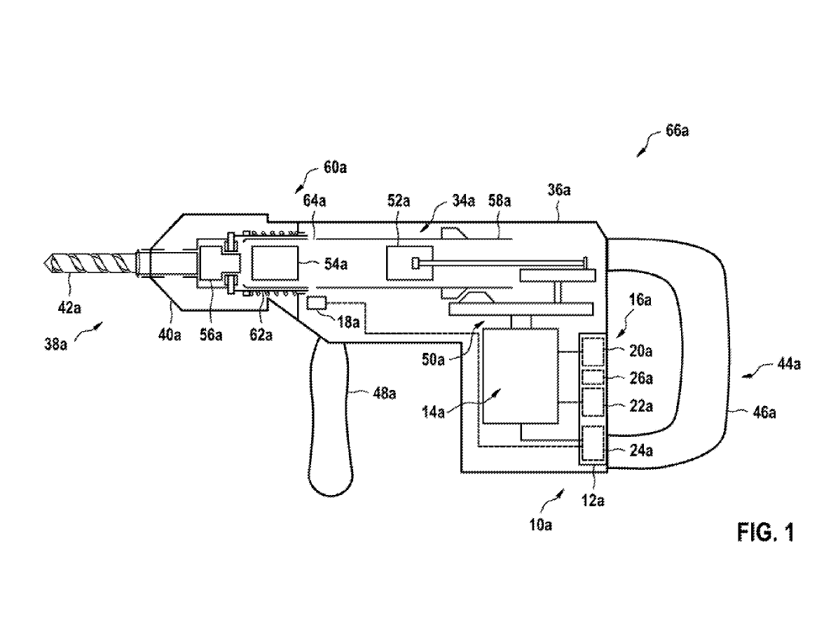

FIG. 1 shows a machine tool 66a which takes the form of a drilling hammer and/or chipping hammer. Consequently the machine tool 66a takes the form of a manual machine tool. However, it is also conceivable that in an alternative configuration, not represented here, the portable machine tool 66a takes the form of a demolition hammer or another manual machine tool appearing appropriate to a person skilled in the art. The machine tool 66a includes at least one striking-mechanism device 34a. The striking-mechanism device 34a has been represented in FIG. 1 merely schematically, in order to elucidate a mode of operation. Furthermore, the machine tool 66a includes a machine-tool housing 36a on which, in a front region 38a, a tool socket 40a of the striking-mechanism device 34a has been arranged for accommodation of an insertion tool 42a. On a side 44a facing away from the front region 38a the machine tool 66a includes a main grip 46a for guidance of the machine tool 66a and for transmission of a force, in particular a pressure force, from an operator to the machine tool 66a. The machine tool 66a has furthermore been constructed with a detachable auxiliary grip 48a. In this regard, the auxiliary grip 48a may have been detachably secured to the machine-tool housing 36a via a detent connection or another connection appearing appropriate to a person skilled in the art.

For generation of a drive torque and for generation of a striking impulse by means of the striking-mechanism device 34a, the machine tool 66a exhibits a drive unit 14a. Via an output unit 50a of the machine tool 66a, a drive torque of the drive unit 14a for generating a striking impulse is transmitted to the striking-mechanism device 34a. However, it is also conceivable that the portable machine tool 66a has been designed to be decoupled from the output unit 50a, and the drive unit 14a acts substantially directly on the striking-mechanism device 34a for generation of a striking impulse. A striking impulse of the striking-mechanism device 34a is generated in a manner already known to a person skilled in the art. In this regard, by means of a reciprocating motion of a striking-impulse element 52a of the striking-mechanism device 34a taking the form of a piston, in at least one striking mode of the striking-mechanism device 34a a pressure is generated for motion of a further striking-impulse element 54a of the striking-mechanism device 34a taking the form of a striker, which is provided for transmission of a striking impulse to a striking pin 56a of the striking-mechanism device 34a. Furthermore, via the output unit 50a the drive torque for generation of a rotary motion of the insertion tool 42a is transmitted to the tool socket 40a via a guide element 58a of the striking-mechanism device 34a taking the form of a hammer tube and/or via a rotary-entrainment element (not represented in any detail here) arranged on the tool socket 40a.

The striking-mechanism device 34a for the machine tool 66a comprises at least the striking-impulse element 52a, at least the guide element 58a for guidance of the striking-impulse element 52a, and at least one idling-opening control unit 60a which exhibits at least one movably supported idling-opening control element 62a for opening and/or for closing at least one idling opening 64a of the guide element 58a. The idling-opening control unit 60a in this case takes the form of a sleeve-type control unit. Consequently the idling-opening control element 62a takes the form of an idling control sleeve. In an idling mode of the striking-mechanism device 34a, in which the idling opening 64a is open and consequently unsealed by the idling-opening control element 62a, the striking-impulse element 52a taking the form of a piston moves in translation within the guide element 58a, taking the form of a hammer tube, from a front dead-center point to a rear dead-center point. However, it is also conceivable that the striking-impulse element 52a taking the form of a piston takes the form of a pot-type piston and in the idling mode of the striking-mechanism device 34a moves in translation relative to other components of the striking-mechanism device 34a which are guided in the pot-type piston, or relative to the machine-tool housing 36a, from a front dead-center point to a rear dead-center point. By this means, a striking impulse is generated as a consequence of a drive of the striking-impulse element 52a taking the form of a piston. For vibration damping, it is conceivable that the machine tool 66a includes a damping unit (not represented in any detail here). In this case the damping unit is provided to damp an oscillation that is capable of being transmitted to an operator of the machine tool 66a.

Moreover, the machine tool 66a includes at least one machine-tool device 10a for control and/or regulation of the machine tool 66a. The machine-tool device 10a takes the form of a manual machine-tool device. In this case, the machine-tool device 10a comprises at least one control and/or regulation unit 12a, for control and/or regulation of a drive unit 14a, and at least one sensor unit 16a, which includes at least one sensor element 18a taking the form of an acceleration sensor. By means of sensor element 18a taking the form of an acceleration sensor, an acceleration of the machine tool 66a caused by the striking-mechanism device 34a can be registered. In this connection, sensor element 18a taking the form of an acceleration sensor is provided to register at least one acceleration proceeding in the striking direction and/or contrary to the striking direction of the striking-mechanism device 34a. In this connection, in a striking mode of the striking-mechanism device 34a the acceleration results from a periodic impact generated by the striking-mechanism device 34a. In an idling mode, the acceleration results from a reciprocating motion of the striking-impulse element 52a taking the form of a piston. This acceleration can be registered in each instance with sensor element 18a taking the form of an acceleration sensor.

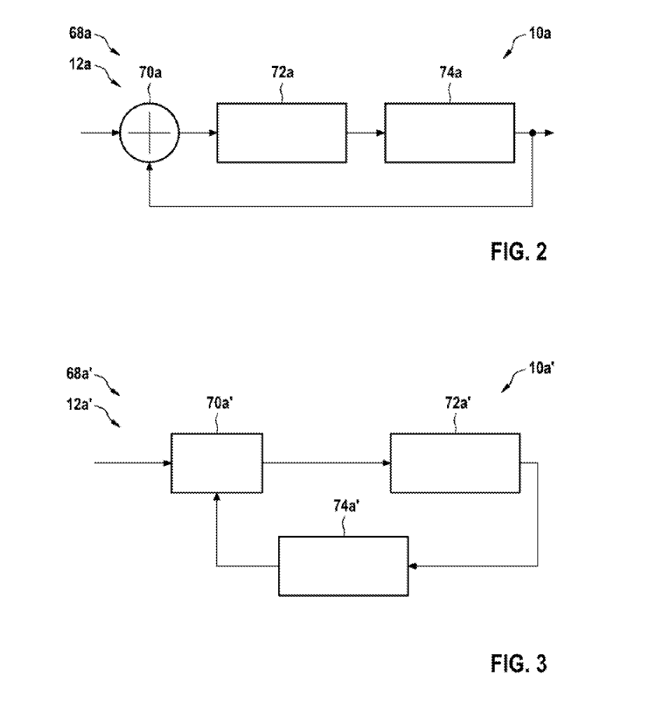

The control and/or regulation unit 12a is provided at least to determine at least one actual rotational speed of the drive unit 14a from a signal of sensor element 18a taking the form of an acceleration sensor. For this purpose, the control and/or regulation unit 12a exhibits a phase-locked-loop unit 68a (FIG. 2) which is provided to determine a frequency from a signal registered by sensor element 18a taking the form of an acceleration sensor. Alternatively, it is conceivable that the control and/or regulation unit 12a includes, instead of the phase-locked-loop unit 68a, a Fourier-analysis unit or a frequency-comb unit for determination of a frequency from a signal registered by sensor element 18a taking the form of an acceleration sensor. In addition, a determination of rotational speed by means of a method for determination of a period of time from a time signal is conceivable, in which a time between two signal peaks or two zero crossings of the acceleration signal is measurable and a frequency is ascertainable therefrom. Depending on a signal quality, in this connection a preprocessing by means of a band-pass filter is appropriate. Alternatively, the time between several signal peaks or zero crossings is ascertainable, by virtue of which the calculated frequency has been averaged over several periods. The phase-locked-loop unit 68a comprises at least one phase detector 70a, a loop filter 72a and a voltage-controlled oscillator 74a. Consequently the phase-locked-loop unit 68a takes the form of an analog phase-locked-loop unit 68a. In a variant, represented in FIG. 3, of the phase-locked-loop unit 68a′ the phase-locked-loop unit 68a′ exhibits a phase detector 70a′, a loop filter 72a′ and a numerically controlled oscillator 74a′. Consequently the variant of the phase-locked-loop unit 68a′ represented in FIG. 3 has been implemented as a digital phase-locked-loop unit 68a′. Consequently a frequency can be determined in structurally simple manner from a signal registered by sensor element 18a taking the form of an acceleration sensor. From this frequency, the control and/or regulation unit 12a calculates an actual rotational speed of the drive unit 14a. Consequently, in a method for control and/or regulation of a rotational speed of the drive unit 14a of the machine tool 66a at least one frequency of a periodic acceleration is determined by means of the control and/or regulation unit 12a, by means of which frequency an actual rotational speed of the drive unit 14a can be determined. In addition, the control and/or regulation unit 12a is provided at least to adjust a rotational speed of the drive unit 14a as a function of a signal of sensor element 18a taking the form of an acceleration sensor.

Moreover, the sensor unit 16a exhibits at least one further sensor element 20a taking the form of a current sensor. The further sensor element 20a taking the form of a current sensor is provided here to register a current consumed by the drive unit 14a. A current value registered by the further sensor element 20a taking the form of a current sensor is transmitted to the control and/or regulation unit 12a. The control and/or regulation unit 12a is provided at least to adjust a rotational speed of the drive unit 14a as a function of a signal of sensor element 18a taking the form of an acceleration sensor and as a function of a signal of the further sensor element 20a taking the form of a current sensor. Furthermore, the sensor unit 16a includes at least one additional sensor element 22a taking the form of a voltage sensor. The additional sensor element 22a taking the form of a voltage sensor is provided here to register a voltage picked up by the drive unit 14a. A voltage value registered by the additional sensor element 22a taking the form of a voltage sensor is transmitted to the control and/or regulation unit 12a. The control and/or regulation unit 12a is consequently provided at least to adjust a rotational speed of the drive unit 14a as a function of a signal of sensor element 18a taking the form of an acceleration sensor, as a function of a signal of the further sensor element 20a taking the form of a current sensor, and as a function of a signal of the additional sensor element 22a taking the form of a voltage sensor.

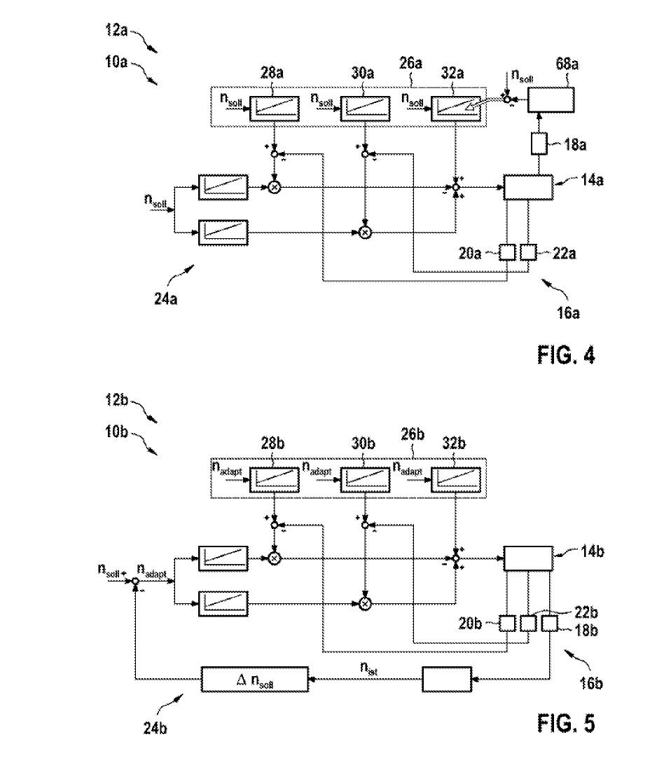

In addition, the control and/or regulation unit 12a includes at least one voltage and/or current regulator 24a for adjustment of the rotational speed of the drive unit 14a, which is provided to take into account a characteristic quantity of the rotational speed that has been generated from a signal of sensor element 18a taking the form of an acceleration sensor (FIG. 4). In this connection, the voltage and/or current regulator 24a is provided to take into account at least one actual rotational speed of the drive unit 14a calculated by means of the control and/or regulation unit 12a from the signal of sensor element 18a taking the form of an acceleration sensor. In addition, for adjustment of the rotational speed of the drive unit 14a the voltage and/or current regulator 24a takes into account the signals of the further sensor element 20a taking the form of a current sensor, and of the additional sensor element 22a taking the form of a voltage sensor. However, it is also conceivable that for adjustment of the rotational speed of the drive unit 14a the control and/or regulation unit 12a calculates from an ignition point of the drive unit 14a a drive-unit voltage that can be made available to the voltage and/or current regulator 24a as an alternative to the signal of the additional sensor element 22a taking the form of a voltage sensor for adjustment of the rotational speed of the drive unit 14a.

The regulation of the rotational speed of the drive unit 14a is consequently undertaken by means of the voltage and/or current regulator 24a. In this connection, an actual rotational speed of the drive unit 14a is determined at regular time-intervals from a signal of sensor element 18a taking the form of an acceleration sensor and is transmitted to the voltage and/or current regulator 24a. The actual rotational speed of the drive unit 14a is furthermore compared by means of the voltage and/or current regulator 24a with a set rotational speed of the drive unit 14a which has been saved in a memory unit 26a of the control and/or regulation unit 12a and which is specific for a mode, such as, for example, a striking mode and/or an idling mode. If a deviation is established by the control and/or regulation unit 12a, control parameters are changed in such a manner that the deviation is kept small. The change (adaptation) of the control parameters is undertaken in this case by at least an order of magnitude that is slower than a regulation of the voltage and/or current regulator 24a, so that no reaction of the adaptation occurs on the regulation by means of the voltage and/or current regulator 24a. The adaptation is preferentially carried out only in a steady state, i.e. when an output signal of the voltage and/or current regulator 24a no longer changes or changes slightly. For this purpose, several parameter characteristics 28a, 30a, 32a have been saved in the memory unit 26a. For adjustment of the rotational speed of the drive unit 14a, the voltage and/or current regulator 24a accesses the parameter characteristics 28a, 30a, 32a saved in the memory unit 26a. The parameter characteristics 28a, 30a, 32a can be evaluated for calculation of an ignition point of the drive unit 14a. In order in steady operation to obtain exactly a desired set rotational speed of the drive unit 14a, at least one of the parameter characteristics 28a, 30a, 32a can be adapted by means of the control and/or regulation unit 12a. If, for example, an actual rotational speed is greater than a set rotational speed of the drive unit 14a, then an applied drive-unit voltage is too high and consequently a value of the ignition point is too low. One of the parameter characteristics 28a, 30a, 32a, in particular a parameter characteristic defining a set ignition point, is adapted by being shifted upward by an offset. The offset is, for example, proportional to a difference between a set speed and an actual speed of the drive unit 14a calculated from the signal of sensor element 18a taking the form of an acceleration sensor. After several adaptation steps, one of the parameter characteristics 28a, 30a, 32a has been set in such a way that the ignition point calculated by the voltage and/or current regulator 24a provides an exact drive-unit voltage, so that the drive unit 14a runs at the desired set speed. Alternatively, it is conceivable that several parameter characteristics 28a, 30a, 32a are adapted simultaneously or successively, or that the parameter characteristics 28a, 30a, 32a are not only shifted upward or downward by an offset, but a slope of the saved parameter characteristics 28a, 30a, 32a varies. Consequently the control and/or regulation unit 12a carries out at least one adaptation of a parameter characteristic 28a, 30a, 32a of the drive unit 14a, saved in a memory unit 26a of the control and/or regulation unit 12a, for adjustment of a set rotational speed of the drive unit 14a. In addition, it is conceivable that at least one operating-condition-dependent rotational speed has been saved in the memory unit 26a, which is adapted as a function of an operating condition of the striking-mechanism device 34a for adjustment of the rotational speed of the drive unit 14a.

Moreover, a recognition of impact is possible by means of the machine-tool device 10a. This is undertaken via sensor element 18a taking the form of an acceleration sensor in combination with sensor element 20a taking the form of a current sensor. In this case, an increase in an acceleration value from the idling mode of the striking-mechanism device 34a relative to the striking mode of the striking-mechanism device 34a can be registered by means of sensor element 18a taking the form of an acceleration sensor. The increase in the acceleration value occurs in a striking direction of the insertion tool 42a and lies within a frequency range of a striking frequency. By means of sensor element 20a taking the form of a current sensor, the striking mode of the striking-mechanism device 34a can be registered via an increased current consumption of the drive unit 14a. The current level is dependent on a rotational speed of the drive unit 14a and on an operating condition of the striking-mechanism device 34a. As a consequence of a signal of sensor element 18a taking the form of an acceleration sensor, an actual rotational speed can be determined, as already described above. In addition, by means of a registration of a current consumption of the drive unit 14a by means of sensor element 20a taking the form of a current sensor, an operating condition of the striking-mechanism device 34a can be inferred. By virtue of the fact that the current level is dependent on a rotational speed of the drive unit 14a and on an operating condition of the striking-mechanism device 34a, a reliable and precise recognition of an operating condition of the striking-mechanism device 34a can consequently be made possible.

FIG. 5 shows a further embodiment of the invention. The following descriptions and the drawings are substantially restricted to the differences between the embodiments, in which connection with reference to identically labelled components, in particular with respect to components having identical reference symbols, reference may also be made, in principle, to the drawings and/or to the description of the other embodiments, in particular the description of FIGS. 1 to 4. For the purpose of distinguishing the embodiments, the letter “a” has been appended to the reference symbols pertaining to the embodiment in FIGS. 1 to 4. In the embodiment shown in FIG. 5, the letter “a” has been replaced by the letter “b”.

An alternative machine-tool device 10b is represented in FIG. 5. In this case the machine-tool device 10b can be arranged, in a manner analogous to that in the description of FIGS. 1 to 4, in a manual power tool (not represented here in any detail). The machine-tool device 10b comprises at least one control and/or regulation unit 12b, for control and/or regulation of a drive unit 14b, and at least one sensor unit 16b, which includes at least one sensor element 18b taking the form of an acceleration sensor. In this connection the control and/or regulation unit 12b is provided at least to determine at least one actual rotational speed of the drive unit 14b from a signal of sensor element 18b taking the form of an acceleration sensor. An adjustment of the rotational speed of the drive unit 14b is undertaken here in a manner at least substantially analogous to the adjustment of the rotational speed described in the description of FIGS. 1 to 4. In contrast to the adjustment of the rotational speed described in FIGS. 1 to 4, in the case of the machine-tool device 10b described in FIG. 5 an adjustment of the rotational speed is undertaken by an adaptation of a set rotational speed of the drive unit 14b which has been transferred to a voltage and/or current regulator 24b of the control and/or regulation unit 12b. In this case, the set rotational speed of the drive unit 14b is transferred to the voltage and/or current regulator 24b which calculates therefrom an ignition point of the drive unit 14b. A control loop is extended in such a way that the voltage and/or current regulator 24b falls back not on a set rotational speed desired by an operator but rather on an adapted set rotational speed of the drive unit 14b. If in the steady state an actual rotational speed of the drive unit 14b is greater than the set rotational speed desired by the operator, the adapted rotational speed is decreased by one step. The voltage and/or current regulator 24b consequently registers a lower set rotational speed in a next step of the calculation and adjusts a drive-unit voltage of the drive unit 14b to a lower value by means of the ignition point. Such an adaptation step is chosen, for example, to be proportional to a difference between the set rotational speed desired by an operator and the actual rotational speed of the drive unit 14b. By this means, in the long term an adapted set rotational speed arises in such a manner that the actual rotational speed corresponds identically to the set rotational speed desired by the operator. In the event of a change from an idling mode to a striking mode, or conversely, for each rotational-speed stage a specific value of an adapted set rotational speed of the drive unit 14b is adjusted. In the event of a renewed change from an idling mode to a striking mode, or conversely, a new adaptation is carried out. If a change is made back to an operating mode already chosen previously, the already adapted value of the adapted set rotational speed continues to be used. With regard to further features and functions of the machine-tool device 10b, reference may be made to the description of FIGS. 1 to 4.

1. A machine-tool device comprising:
at least one sensor unit including at least one sensor element taking form of an acceleration sensor; and
at least one control and/or regulation unit configured to (i) at least one of control and regulate a drive unit and
(ii) determine at least one actual rotational speed of the drive unit from a signal of the acceleration sensor.

2. The machine-tool device as claimed in claim 1, wherein the control and/or regulation unit is further configured to adjust a rotational speed of the drive unit as a first function of the signal of the acceleration sensor.

3. The machine-tool device as claimed in claim 1, wherein the sensor unit further includes at least one further sensor element taking form of a current sensor.

4. The machine-tool device as claimed in claim 3, wherein the control and/or regulation unit is further configured to adjust a rotational speed of the drive unit as a first function of the signal of the acceleration sensor and as a second function of the signal of the current sensor.

5. The machine-tool device as claimed in claim 1, wherein the sensor unit further includes at least one additional sensor element taking form of a voltage sensor.

6. The machine-tool device as claimed in claim 5, wherein the control and/or regulation unit is further configured to adjust a rotational speed of the drive unit as a first function of the signal of the acceleration sensor, as a second function of a signal of a further sensor element taking form of a current sensor, and as a third function of a signal of the sensor.

7. The machine-tool device as claimed in claim 1, wherein the control and/or regulation unit includes at least one voltage and/or current regulator configured to adjust the rotational speed of the drive unit,
wherein the drive unit is configured to take into account a characteristic quantity of the rotational speed generated from the signal of the acceleration sensor.

8. A machine tool, comprising:
at least one machine-tool device, the at least one machine-tool device including:
at least one sensor unit including at least one sensor element taking form of an acceleration sensor; and
at least one control and/or regulation unit configured to (i) at least one of control and regulate a drive unit and (ii) determine at least one actual rotational speed of the drive unit from a signal of the acceleration sensor.

9. A method for at least one of controlling and regulating a rotational speed of a drive unit of a machine tool with at least one machine-tool device, the one machine-tool device comprising:
at least one sensor unit including at least one sensor element taking form of an acceleration sensor; and
at least one control and/or regulation unit configured to (i) at least one of control and regulate a drive unit and (ii) determine at least one actual rotational speed of the drive unit from a signal of the acceleration sensor.

10. The method as claimed in claim 9, further comprising:
determining at least one frequency of a periodic acceleration using the control and/or regulation unit to determine an actual rotational speed of the drive unit.

11. The method as claimed in claim 10, wherein the control and/or regulation unit is configured to adapt a parameter characteristic of the drive unit to adjust a set rotational speed of the drive unit,
wherein the parameter characteristic of the drive unit is saved in a memory unit of the control and/or regulation unit.

12. The method according to claim 1, wherein the machine-tool device is a manual machine-tool device.

13. The method according to claim 8, wherein the machine tool is a manual machine tool.
